(19) United States
(12) Patent Application Publication
(10) Pub. No.: US 2026/0308960 A1
(43) Pub. Date: Oct. 8, 2026

(54) Hinge Damper

(71) Applicant: Illinois Tool Works Inc., Glenview, IL (US)

(72) Inventors: Dennis Mark, Hawthorne Woods, IL (US); Thomas G. Deppisch, Creglingen (DE); Boris Fuisting, Wustenriet (DE); Christian Statt, Wurzburg (DE); Jurgen Hilpert, Frickenhausen (DE); Colin McMahon, Tinley Park, IL (US)

(21) Appl. No.: 19/633,925

(22) Filed: Mar. 30, 2026

Related U.S. Application Data
(60) Provisional application No. 63/783,407, filed on Apr. 4, 2025.
(60) Provisional application No. 63/790,828, filed on Apr. 18, 2025.
(60) Provisional application No. 63/843,498, filed on Jul. 14, 2025.
(60) Provisional application No. 63/954,198, filed on Jan. 5, 2026.

(51) Int. Cl. E05D 11/08; E05F 5/02

(52) U.S. Cl. CPC E05D 11/084; E05F 5/02; E05D 2011/085

(57) ABSTRACT

A damper assembly includes an assembly housing, an axle disposed within the assembly housing and configured to rotate relative thereto, and at least one damper component coupled to the axle. The damper component is configured to provide resistance to rotational movement of the axle relative to the assembly housing. In some embodiments, a pair of damper components are positioned at opposite ends of the axle, and each damper component includes a rotor rotatable within an outer casing containing a damping medium. The axle may include an engagement interface accessible through an opening in the assembly housing for coupling to an external component. The damper assembly may be configured for use between relatively movable components to control motion therebetween.

### RELATED APPLICATIONS

The present application claims priority to U.S. Provisional Patent Application No. 63/783,407, filed Apr. 4, 2025; U.S. Provisional Patent Application No. 63/790,828, filed Apr. 18, 2025; U.S. Provisional Patent Application No. 63/843,498, filed Jul. 14, 2025, and U.S. Provisional Patent Application No. 63/954,198, filed Jan. 5, 2026; each of which is entitled “Hinge Damper” and hereby incorporated by reference in its entirety.

### BACKGROUND

Dampers are commonly used in mechanical systems to control motion between relatively movable components. In many applications, a damper is configured to resist or moderate movement so that a component does not move too quickly or abruptly relative to another component. By providing a controlled resistance to motion, dampers can improve perceived quality, reduce noise, and prevent damage or excessive wear associated with uncontrolled movement.

Movement dampers of various types are used in assemblies and applications to control the movement of assembly components. For example, movement dampers can be used to control movement in at least one direction of a drawer or door in furniture, cabinets and appliances. In the automotive field, movement damper can be used on, for example, glove box and console doors as well as other doors and closures for bins, storage areas, and the like. Example movement dampers include rotary dampers. A rotary damper generally comprises a housing and a rotor rotatable in the housing, with a shaft of the rotor extending outwardly from the housing to receive a gear thereon to, in turn, engage a gear on the device being controlled. In some rotary dampers of this type, a viscous fluid is provided in the housing, which is then sealed. Damping performance is facilitated by resistance of the fluid to rotation of the rotor within the sealed housing.

In vehicle interiors and other enclosed storage systems, for example, movable lids or doors are often pivotably mounted to a housing or compartment structure. When such a lid is released from a closed position, gravitational forces may cause the lid to rotate rapidly toward an open position. Without motion control, the lid may drop abruptly, which can result in undesirable noise, user discomfort, or potential damage to the lid, hinges, or surrounding structures.

Accordingly, various damping mechanisms have been developed to slow the motion of movable doors or lids, such as those associated with glove compartments or similar storage compartments. However, existing dampers may present limitations in terms of packaging constraints, durability, manufacturability, or motion control characteristics. Therefore, there remains a need for improved dampers and damping arrangements capable of providing controlled motion between relatively movable components.

### SUMMARY

The present disclosure relates generally to a movement dampers and, more particularly to a rotary hinge damper assembly substantially as illustrated by and described in connection with at least one of the figures, as set forth more completely in the claims.

### DRAWINGS

The foregoing and other objects, features, and advantages of the devices, systems, and methods described herein will be apparent from the following description of examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A illustrates a perspective view of a damping system in accordance with an aspect of the present disclosure, including a damper assembly coupled between a first component and a second component.

FIG. 1B illustrates an enlarged perspective view of an interface between the first component and the second component, with the damper assembly coupled therebetween.

FIG. 1C illustrates a cross-sectional view of the damper assembly, taken along cutline A-A of FIG. 1B.

FIG. 1D illustrates an enlarged perspective view of the interface between the first component and the second component, with the damper assembly omitted.

FIG. 1E illustrates a side elevation view of a first mounting bracket at the interface between the first component and the second component.

FIG. 1F illustrates a perspective view of the first mounting bracket at the interface between the first component and the second component.

FIG. 1G illustrates a side elevation cross-sectional view of a second mounting bracket at the interface between the first component and the second component, taken along cutline A-A of FIG. 1B.

FIG. 1H illustrates a perspective view of the second mounting bracket at the interface between the first component and the second component.

FIG. 2A illustrates a perspective view of the damper assembly.

FIG. 2B illustrates a perspective cross-sectional view of the damper assembly, taken along cutline B-B of FIG. 2A.

FIG. 2C illustrates a perspective assembled view of the damper assembly.

FIG. 2D illustrates a first perspective assembly view of the damper assembly.

FIG. 2E illustrates a second perspective assembly view of the damper assembly.

FIG. 3A illustrates a side elevation cross-sectional view of the damper assembly, taken along cutline B-B of FIG. 2A, in a first position configured to dampen movement in a first direction.

FIG. 3B illustrates a side elevation cross-sectional view of the damper assembly, taken along cutline B-B of FIG. 2A, in an intermediate position.

FIG. 3C illustrates a side elevation cross-sectional view of the damper assembly, taken along cutline B-B of FIG. 2A, in a third position configured to dampen movement in a second direction.

FIG. 4 illustrates a perspective view of a damper assembly with extendable pins.

### DESCRIPTION

References to items in the singular should be understood to include items in the plural, and vice versa, unless explicitly stated otherwise or clear from the text. Grammatical conjunctions are intended to express all disjunctive and conjunctive combinations of conjoined clauses, sentences, words, and the like, unless otherwise stated or clear from the context. Recitation of ranges of values herein are not intended to be limiting, referring instead individually to all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to a damper assembly, more particularly to a rotary hinge damper assembly. In one example, a damper assembly is provided for controlling motion between a first component and a second component. The damper assembly includes an assembly housing configured to be coupled to at least one of the first component or the second component. An axle is disposed at least partially within the assembly housing and is configured to rotate relative to the assembly housing. The axle is further configured to be coupled to the other of the first component or the second component. At least one damper component is coupled to the axle and positioned within the assembly housing. The at least one damper component is configured to provide resistance to rotation of the axle relative to the assembly housing.

In some examples, the damper assembly includes a pair of damper components positioned at opposite ends of the axle. This arrangement can provide balanced damping forces and improved load distribution along the axle.

In some examples, the assembly housing includes a central region and a pair of end regions. The central region is configured to receive at least a portion of the axle, while the end regions are configured to receive and retain the at least one damper component.

In some examples, the assembly housing includes an opening extending through a sidewall of the assembly housing. The opening provides access to the axle, for example, to facilitate coupling between the axle and one of the first or second components.

In some examples, the axle includes an engagement interface that is accessible through the opening and is configured to couple the axle to the other of the first component or the second component. The engagement interface may include one or more grooves, slots, or similar features configured to receive a corresponding coupling feature.

In some examples, the engagement interface comprises at least one groove or slot formed in the axle.

In some examples, the axle includes a plurality of longitudinally extending spars. The spars may extend along a length of the axle and contribute to structural rigidity while reducing material usage.

In some examples, the plurality of spars define an X-shaped cross-section. This configuration can provide a desirable balance between strength and weight.

In some examples, a plurality of ribs extend between adjacent spars. The ribs may provide additional structural support and may also define functional features of the axle.

In some examples, at least a portion of the ribs define the engagement interface of the axle, such as by forming grooves or slots configured to receive a mating feature.

In some examples, the at least one damper component includes an outer casing that is fixed relative to the assembly housing and a rotor disposed within the outer casing and coupled to the axle. The rotor is configured to rotate relative to the outer casing.

In some examples, the outer casing defines a chamber that contains a viscous damping medium, such as a fluid or gel, which provides resistance to motion.

In some examples, the rotor is configured to rotate relative to the outer casing to generate a damping torque, for example, by displacing and shearing the viscous damping medium within the chamber.

In some examples, the axle includes an axle-coupling feature and the rotor includes a corresponding damper-coupling feature configured to engage the axle-coupling feature.

In some examples, the axle-coupling feature includes a pair of sidewalls defining a receiver recess.

In some examples, the receiver recess is configured to provide a predetermined amount of rotational play between the axle and the rotor prior to transmission of torque. This rotational play permits relative movement before engagement, allowing for controlled initiation of damping.

In some examples, the receiver recess includes a narrower region and one or more wider regions. The one or more wider regions provide clearance to permit relative rotation between the axle and the rotor, while the narrower region defines an engagement condition at which rotation of the axle is transferred to the rotor.

In some examples, the receiver recess has a bowtie-shaped geometry defining the narrower region between opposing wider regions. This geometry facilitates insertion of a mating feature while enabling the predetermined rotational play prior to engagement.

In some examples, the damper-coupling feature includes at least one insert configured to be received within the receiver recess. The at least one insert is movable within the receiver recess through the predetermined amount of rotational play prior to engagement with the axle-coupling feature, after which rotation of the axle is transmitted to the rotor to generate damping.

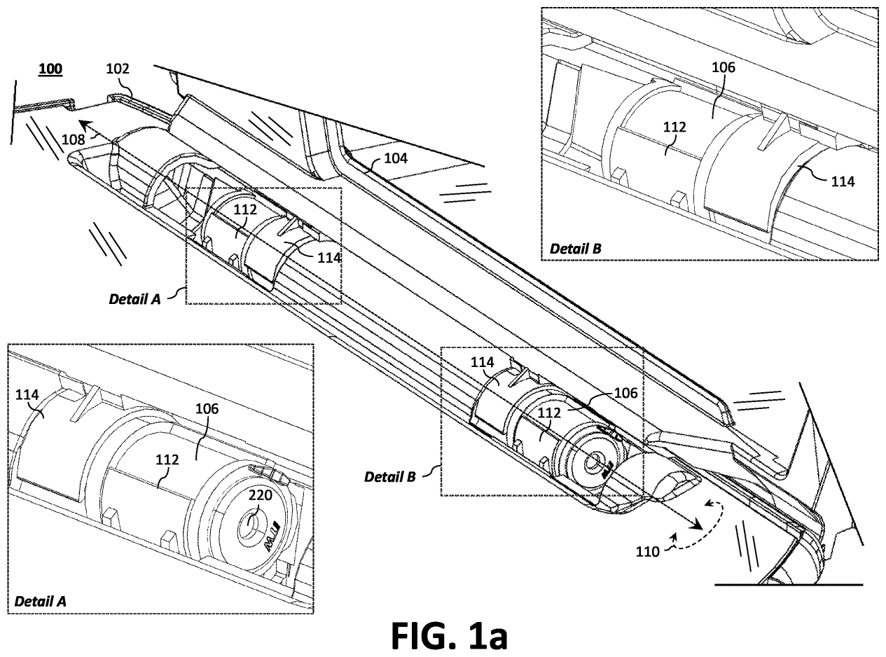

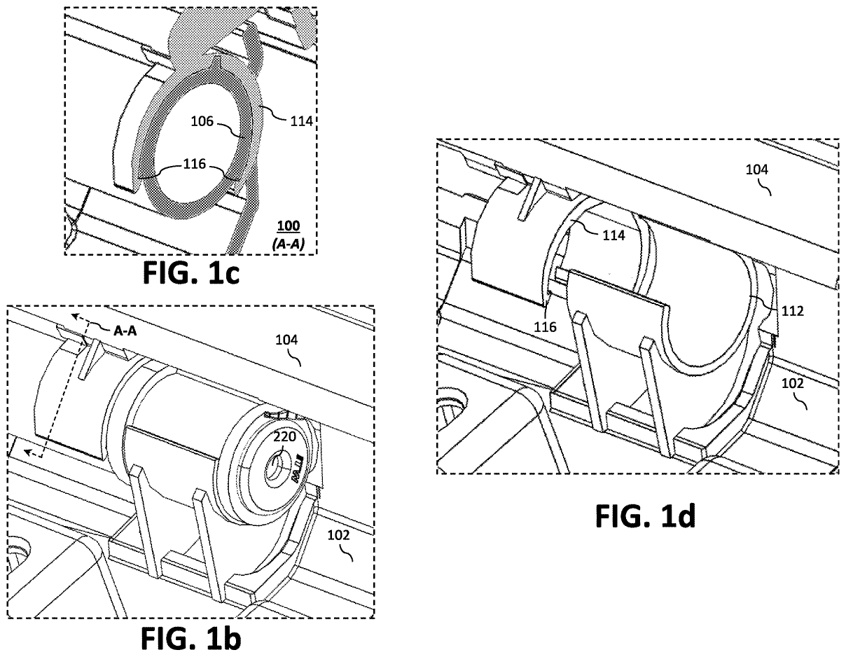

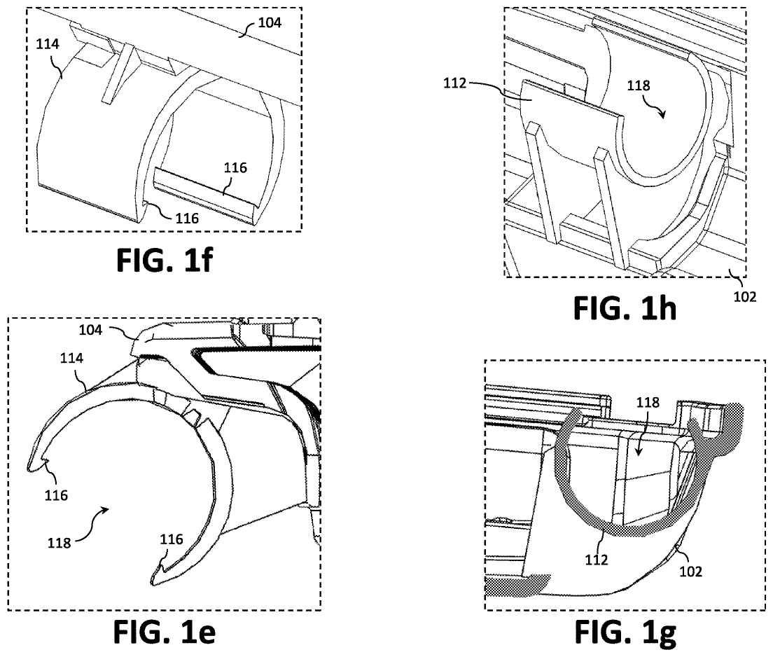

FIGS. 1A through 1H illustrate various views of a damping system 100 and its interface components. The damping system 100 includes a damper assembly 106 operatively positioned between the first component 102 and the second component 104. In the illustrated example, the first component 102 and the second component 104 are pivotally coupled to one another about an axis 108 such that the first component 102 is movable relative to the second component 104, as indicated by arrow 110, between a closed position and an open position. FIG. 1A shows a perspective view of the damping system including a damper assembly 106 coupled between a first component 102 and a second component 104. FIGS. 1B and 1D provide enlarged perspective views of the interface between the first and second components, with FIG. 1B including the damper assembly and FIG. 1D omitting the damper assembly. FIG. 1C presents a cross-sectional view of the damper assembly taken along cutline A-A of FIG. 1B. FIGS. 1E and 1F illustrate side elevation and perspective views, respectively, of a first mounting bracket, while FIGS. 1G and 1H illustrate cross-sectional and perspective views, respectively, of a second mounting bracket at the interface.

The damper assembly 106 of the damping system 100 is configured to provide both a soft-close functionality and a reduction in lift effort for the first component 102 relative to the second component 104. In particular, the damper assembly 106 is configured such that peak operating forces experienced over the total travel of the first component 102 are reduced relative to conventional hinge arrangements, including those that rely on separate spring elements. In this manner, the damper assembly 106 can reduce the effort required by a user to initiate opening of the first component 102, while also providing controlled resistance during closing.

The first component 102 may comprise a movable closure member such as a lid, door, or panel. In one non-limiting example, the first component 102 is configured as a glove compartment door of a vehicle interior storage system. The first component 102 can be a multi-component assembly (e.g., a lid with a liner). The second component 104 may comprise a structural body, housing, or cavity associated with the storage system, such as a glove compartment housing mounted within a vehicle dashboard. The second component 104 can likewise be a multi-component assembly.

While described in connection with a glove compartment door of a vehicle interior storage system, the damping system 100, more particularly the damper assembly 106, is not limited to this application and may be used in any system in which controlled relative motion between components is desired. The damper assembly 106 is particularly well suited for use in applications such as a center armrest console, glove compartment, or other vehicle storage systems in which a movable component is pivotally coupled to a housing. However, the damper assembly 106 may also be used in other applications in which two components are required to move or rotate relative to one another with controlled motion.

As shown, the first component 102 includes a plurality of first brackets 112, and the second component 104 includes a plurality of second brackets 114. Each of the first brackets 112 and second brackets 114 may be generally curved and configured to define a receiver cavity 118 sized and shaped to receive a portion of the damper assembly 106. As best illustrated in FIGS. 1E through 1H, the first and second brackets 112, 114 may have generally C-shaped cross-sectional profiles, although other partially circumferential or arcuate geometries may be used. The C-shaped geometry allows the brackets to snap over cylindrical or partially cylindrical portions of the damper assembly 106 to facilitate assembly and retention.

The first and second brackets 112, 114 may be configured to elastically deform during installation such that the receiver cavity 118 temporarily expands to receive the damper assembly 106 and then contracts to retain the assembly. In this manner, the first and second brackets 112, 114 can function as hinge elements that both support the damper assembly 106 and allow relative rotation between the first component 102 and the second component 104.

In some aspects, one or more of the first brackets 112 and/or second brackets 114 include grip features configured to engage corresponding surfaces of the damper assembly 106 to inhibit relative rotation between the brackets and the damper assembly. In the illustrated example, the second brackets 114 include grip features in the form of snaps 116. The snaps 116 may be configured as inwardly extending protrusions, detents, or resilient tabs that at least partially surround and engage portions of the damper assembly 106, such as fixturing regions 120, 122 formed on the outer surface of the damper assembly 106. The snaps 116 may engage complementary recesses, flats, or contours on the damper assembly 106 to provide rotational fixation and/or axial retention. In other examples, the grip features can be provide in the form of a liner, coating, or textured surface to increase friction between the first brackets 112 and/or second brackets 114 with the damper assembly 106, thus mitigating slippages.

The damper assembly 106 is arranged such that relative motion between the first component 102 and the second component 104 results in actuation of the damper assembly 106. Rotation of the first component 102 about the axis 108 relative to the second component 104 results in corresponding relative rotation between internal components of the damper assembly 106. The damper assembly 106 is configured to generate a resistive torque that opposes this relative motion, thereby controlling the rate of movement. For example, when the first component 102 is released from a closed position, gravitational forces may tend to cause the first component 102 to rotate toward the open position. The damper assembly 106 resists this motion, allowing the first component 102 to open in a controlled and gradual manner.

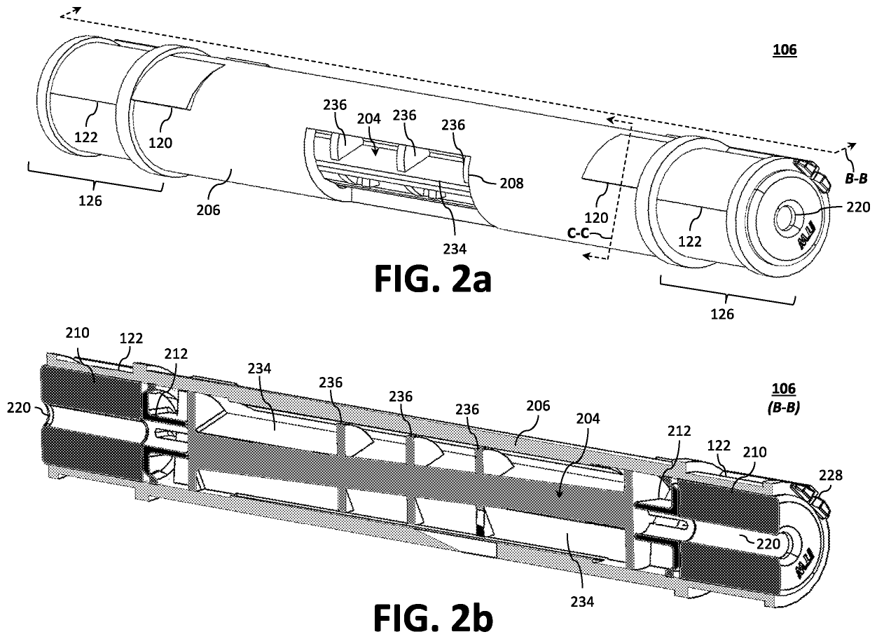

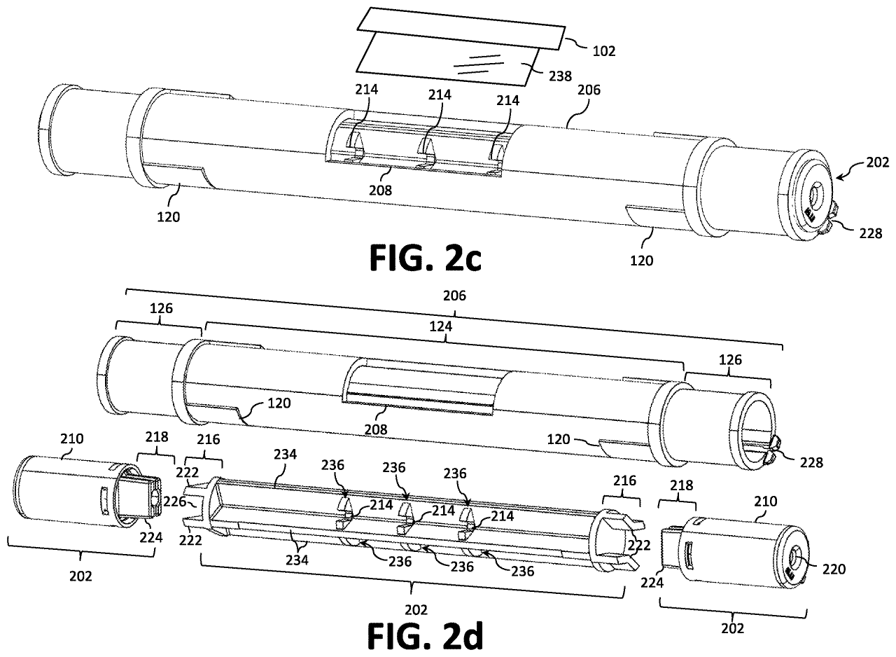

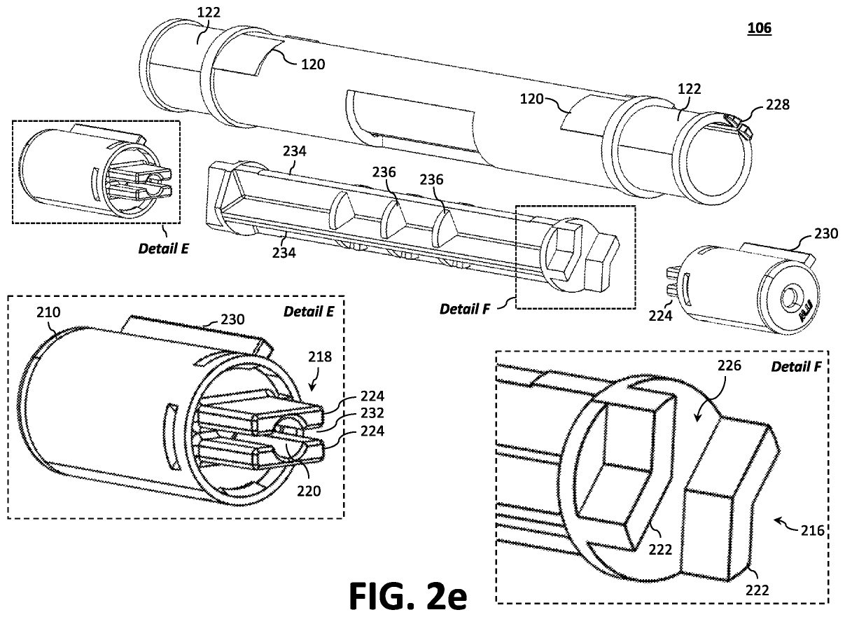

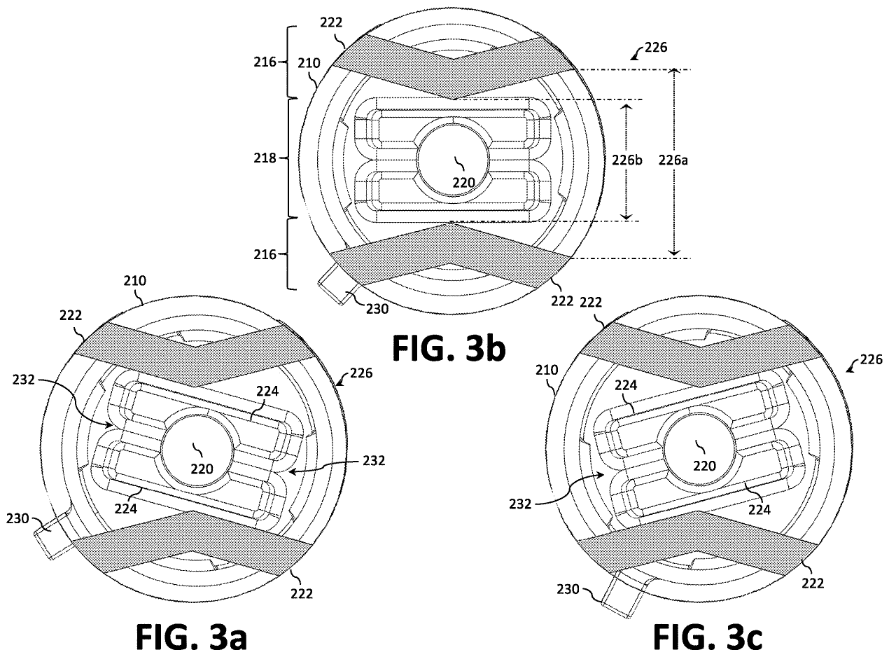

Turning to FIGS. 2A through 2E and FIGS. 3A through 3C, the damper assembly 106 generally comprises an assembly housing 206, an axle 204, and a pair of damper components 202. FIGS. 2A through 2E illustrate various views of the damper assembly 106. FIG. 2A shows a perspective view of the damper assembly, and FIG. 2B shows a perspective cross-sectional view taken along cutline B-B of FIG. 2A. FIG. 2C illustrates a fully assembled perspective view, while FIGS. 2D and 2E illustrate first and second perspective assembly views, respectively. FIGS. 3A through 3C illustrate operational positions of the damper assembly 106 in cross-section, taken along cutline B-B of FIG. 2A. FIG. 3A shows the damper assembly in a first position configured to dampen movement in a first direction, FIG. 3B shows an intermediate position, and FIG. 3C shows a third position configured to dampen movement in a second direction.

In some aspects, the damper assembly 106 is configured to provide optimized damping characteristics over the range of motion between the first component 102 and the second component 104. For example, the damper components 202 may be configured to provide a relatively lower or partial damping torque during an initial portion of movement (e.g., during initial lifting of the first component 102 from a closed position or during initial closing movement). This reduced damping torque may facilitate ease of actuation and reduce perceived resistance to user input. The can be accomplished by, for example, the configuration of the mechanical connection between the damper components 202 and the axle 204 (e.g., the axle-coupling and damper-coupling features 216, 218). As movement continues, the damper components 202 may provide an increased or full damping torque during a later portion of travel, such as a final portion of closing movement. This increased damping torque enables a soft-close effect in which the first component 102 is slowed and gently brought to a closed position, thereby avoiding abrupt impact or noise. The use of a pair of damper components 202 positioned at opposite ends of the axle 204 may provide increased damping capacity, improved load distribution, and enhanced durability relative to configurations employing a single damper. Additionally, the distributed arrangement may facilitate packaging within constrained spaces and may allow for modular assembly.

The pair of damper components 202 can be configured to provide direction control in the same or opposite directions. For example, one damper component 202 can provide dampening in a first direction (e.g., when opening) and the other damper component 202 can provide dampening in a second direction (e.g., when closing). The dampening force can be configured such that the pair of damper components 202 generally maintain the first component 102 in a desired position (e.g., an intermediate position) absent a force.

The damper assembly 106 may further be configured to provide a position-holding function over at least a portion of its travel. For example, the damping characteristics and/or internal friction of the damper components 202 may be selected such that the first component 102 is maintained in a partially open position (e.g., up to approximately 18 degrees relative to a fully closed position) without requiring additional holding mechanisms. This position-holding capability may be achieved through the interaction of the viscous damping medium, internal rotor features of the rotor 212, and any frictional interfaces within the damper assembly 106.

The damper assembly 106 may be configured to eliminate the need for separate biasing elements, such as springs, that are commonly used in conventional hinge systems to assist with opening or to control closing motion. By both providing a reduced lift effort and closing damping functionality in the damper assembly 106, the overall system complexity may be reduced. This elimination of springs may result in reduced part count, reduced mass, and reduced packaging constraints within the overall system.

In addition, the integration of multiple functions into the damper assembly 106 may reduce the number of individual components and associated part numbers. This reduction may simplify supply chain management and assembly processes. The damper assembly 106 may therefore provide both functional and manufacturing advantages, including improved reliability due to fewer discrete components.

The configuration of the damper assembly 106 may further provide advantages at the assembly level. For example, the damper assembly 106 may be provided as a single, integrated unit that can be handled and installed as one part. This may reduce assembly time and complexity by eliminating the need for multiple assembly steps associated with conventional hinge and damping systems.

In some aspects, the damper assembly 106 may be installed using snap-fit or slide-in techniques, rather than requiring alignment and insertion of separate hinge pins or fasteners. To that end, the first brackets 112 and second brackets 114 may be configured to facilitate such simplified assembly. As described, the first brackets 112 may be provided on the first component 102 (e.g., a movable lid), while the second brackets 114 may be provided on the second component 104 (e.g., a housing). The first brackets 112 may be configured to engage the assembly housing 206 in a manner that permits rotation while maintaining axial retention. The second brackets 114 may be configured to provide additional fixation, including centering of the damper assembly 106 along the axis 108 and inhibiting rotation of the assembly housing 206 relative to the second component 104.

By providing complementary engagement features on both the first component 102 and the second component 104, the damping system 100 may eliminate the need for additional components such as hinge pins, metal plates, fasteners, or separate brackets. This may reduce overall system weight and cost, while also improving packaging efficiency. In some aspects, the damper assembly 106 may further define a built-in travel limit for the first component 102, thereby eliminating the need for separate stop features.

The snap-fit engagement provided by the first brackets 112 and second brackets 114 may enable rapid and intuitive assembly. For example, the damper assembly 106 may be installed by aligning the assembly housing 206 with the first and second brackets 112, 114 and applying a force to snap the brackets into engagement. This approach may reduce assembly time and minimize the need for specialized tools or fixtures. Additionally, the snap-fit configuration may allow for easy removal and replacement of the damper assembly 106, if desired.

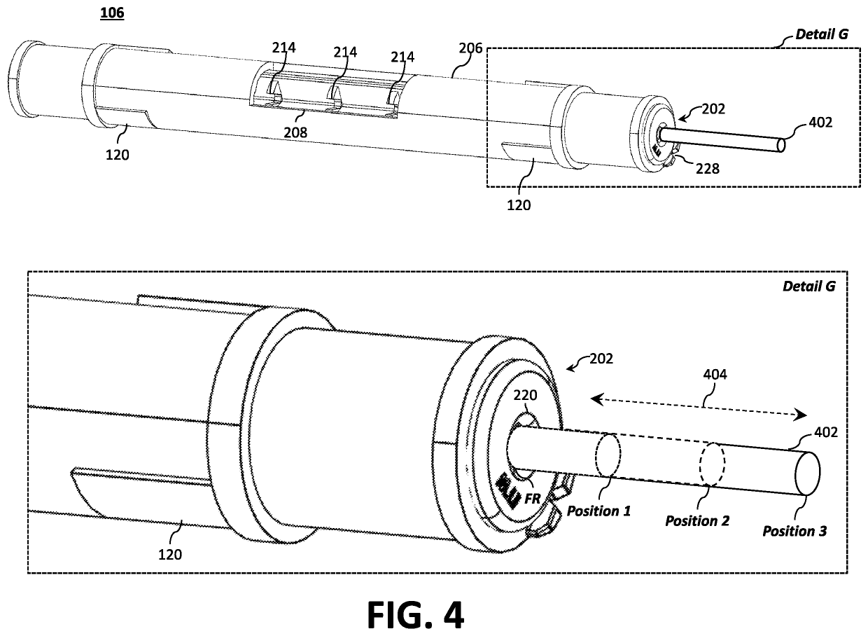

In some aspects, one or more pins may be used in addition to, or as an alternative to, the snap-fit features described above. FIG. 4 illustrates a perspective view of a damper assembly with extendable pins. For example, with reference to FIG. 4, a pin 402 (e.g., a rod configured to serve as a hinge pin) may be inserted into the pin recess 220 of the damper component 202 to provide additional structural support, alignment, and/or pivot functionality.

In some examples, the pin 402 is extendable relative to the pin recess 220. For instance, the pin 402 may be configured to translate axially (e.g., extend and/or retract) with respect to the pin recess 220, as indicated by arrow 404, to achieve a desired effective length or engagement depth. The pin 402 may be configured to move freely within the pin recess 220, or to selectively engage the pin recess 220 to assume and maintain one or more discrete or continuous positions.

The pin 402 may be retained or positionally secured relative to the pin recess 220 using a variety of engagement mechanisms. By way of example, such mechanisms may include threaded engagement (e.g., external threads on the pin 402 engaging internal threads of the pin recess 220), detent features (e.g., spring-loaded balls or protrusions engaging corresponding recesses), interference or press fits, frictional engagement, ratcheting or sawtooth profiles, collet-type expansion features, cam-lock or quarter-turn locking features, bayonet-style engagements, keyed or splined interfaces, set-screw or clamp-based retention, magnetic retention, or elastomeric elements providing bias and positional stability. In some implementations, the pin 402 may include radially expandable portions (e.g., split shafts, flexures, or deformable sleeves) that selectively engage an interior surface of the pin recess 220 to maintain a desired position.

In the illustrated example, the pin 402 is configured to translate within the pin recess 220 between a fully retracted (FR) position, a first extended position (Position 1), a second extended position (Position 2), and a fully extended position (Position 3). While discrete positions are shown, it should be appreciated that the pin 402 may alternatively support continuously variable positioning or a greater or lesser number of indexed positions depending on the configuration of the engagement features.

Although a pin 402 is illustrated on only one side, a corresponding pin arrangement may be provided on one or both sides of the damper assembly 106. Even in such configurations, the overall number of components may remain reduced relative to conventional systems, and the need for separate biasing elements (e.g., springs) or complex fastening arrangements may be minimized or eliminated.

The damper components 202 may be coupled to the assembly housing 206, for example within the end regions 126, using a variety of retention and anti-rotation features. In some aspects, friction zones, detents, ribs, or other surface features may be provided on the interior surface of the assembly housing 206 (e.g., near the opening 208) to engage corresponding surfaces of the outer casing 210 of the damper components 202. These features may provide resistance to rotation and/or axial movement of the damper components 202 relative to the assembly housing 206. Additionally or alternatively, friction zones, detents, ribs, or other surface features may be provided on an exterior surface of the assembly housing 206 to engage the first component 102 or second component 104 at a sliding or mounting interface. These features may enhance stability and reduce unwanted movement between the damper assembly 106 and surrounding components.

The axle 204 is configured to engage the first component 102 via the engagement interface 214 for in, on, or by the axle 204. In some aspects, a portion of the first component 102 may extend into the opening 208 of the assembly housing 206 and engage the engagement interface 214 of the axle 204. For example, a tab, flag, or bracket (e.g., a dampening interface flag 238 as illustrated in FIG. 2c) may be fixed to the first component 102 and inserted into the engagement interface 214 defined by the axle 204. The dampening interface flag 238 may have a geometry complementary to the grooves or slots forming the engagement interface 214, or to any of a variety of mating geometries including, but not limited to, flats, splines, keyed profiles, polygonal interfaces, interference features, or other interlocking configurations, such that rotation of the first component 102 results in corresponding rotation of the axle 204.

As the first component 102 pivots about the axis 108, the dampening interface flag 238 transmits motion to the axle 204, which in turn drives rotation of the rotors 212 of the damper components 202. The damping provided by the damper components 202 resists this motion, thereby controlling the rate of rotation. This arrangement allows the damper assembly 106 to be effectively integrated into the hinge system while maintaining a compact design. Thus, the damper assembly 106 provides a compact, integrated solution for controlling motion between relatively movable components. By combining damping, lift effort reduction, and structural hinge functionality into a single assembly, the damper assembly 106 can reduce component count, simplify assembly, and improve performance relative to conventional systems.

The pair of damper components 202 may include a first damper component 202 and a second damper component 202 positioned at opposite ends of the axle 204. Each damper component 202 is configured to function as a rotary damper that provides resistance to rotational movement.

Where desired, the assembly housing 206 may be configured to receive and retain the axle 204 and the damper components 202. In the illustrated example, the assembly housing 206 defines a central region 124 and a pair of end regions 126. The central region 124 is configured to receive at least a portion of the axle 204, while the end regions 126 are configured to receive and retain the damper components 202. Although illustrated as having distinct regions, the assembly housing 206 may be formed as a unitary structure, such as by injection molding, casting, machining, or additive manufacturing. Alternatively, the assembly housing 206 may be formed from multiple components that are subsequently joined, for example by welding, fastening, adhesive bonding, or snap-fit engagement.

The assembly housing 206 defines an internal cavity extending along at least a portion of its length for receiving the axle 204 and portions of the damper components 202. The housing 206 may be formed from a rigid or semi-rigid material, including but not limited to thermoplastic polymers, thermoset polymers, metals, or composite materials. Material selection may be based on factors such as strength, wear resistance, chemical compatibility with damping fluids, and manufacturing considerations.

The central region 124 of the assembly housing 206 may include one or more fixturing regions 120, 122 configured to facilitate engagement with external components such as first and second brackets 112, 114. The fixturing regions 120, 122 may include flats, grooves, raised portions, recessed portion, or contoured surfaces that provide anti-rotation features and improve positional stability during installation and operation. The fixturing regions 120 may be integrally formed with the housing 206 or may be provided as separate features coupled thereto.

An opening 208 is formed through a sidewall of the assembly housing 206, for example in the central region 124. The opening 208 provides access to a portion of the axle 204 disposed within the housing 206. The opening 208 may be sized and shaped to permit insertion of a tool, coupling member, or a structural element for engagement with the axle 204 (e.g., dampening interface flag 238). The opening 208 may be positioned at or near a midpoint of the housing 206, although other positions are contemplated.

The axle 204 extends through the assembly housing 206 and is configured to rotate relative to the housing 206. The axle 204 may extend along a longitudinal axis of the assembly housing 206 and may be supported by one or more bearing surfaces, bushings, or internal supports formed within the housing 206. The axle 204 may be formed from a rigid material such as polymers, metals, or reinforced polymers, and may be manufactured using extrusion, molding, machining, or other suitable processes.

The axle 204 includes an engagement interface 214 accessible through the opening 208. The engagement interface 214 may be configured to receive a mating component, such as a tab, pin, the dampening interface flag 238, or other coupling feature associated with the first component 102 or second component 104. In some aspects, the engagement interface 214 may be defined by one or more grooves, slots, recesses, flats, or other geometric features formed in the axle 204. In the illustrated example, the engagement interface 214 is at least partially defined by features formed by ribs 236 extending between spars 234.

The axle 204 may include a plurality of spars 234 extending longitudinally along the length of the axle. In the illustrated example, the spars 234 are arranged to define a generally X-shaped cross-section. This configuration provides structural rigidity while reducing material usage and weight. A plurality of ribs 236 may be positioned between adjacent spars 234 to provide additional structural support and to define functional features. The ribs 236 may have curved profiles, such as quarter-circle shapes, and may be spaced along the length of the axle 204. In some examples, three ribs 236 are positioned between each pair of adjacent spars 234. Selected ribs 236 may be configured to collectively define the engagement interface 214 by forming one or more grooves or slots.

Each end of the axle 204 includes an axle-coupling feature 216 configured to engage a corresponding damper-coupling feature 218 of a respective damper component 202. In the illustrated example, the axle-coupling feature 216 includes a pair of sidewalls 222 extending from the end of the axle 204. The sidewalls 222 may be spaced apart to define a receiver recess 226. The sidewalls 222 may be planar, curved, or canted (angled) relative to one another. In some aspects, the sidewalls 222 are angled such that the receiver recess 226 has a variable width configured to permit a predetermined amount of rotational play (e.g., lost motion) of the axle 204 relative to the damper component 202 prior to engagement that results in transmission of torque and corresponding damping in each rotational direction.

With reference to FIGS. 3A through 3C, the receiver recess 226 may have a geometry resembling a bowtie configuration, including wider regions 226a with a narrower intermediate region 226b. The narrower region 226b may correspond to a minimum spacing between the sidewalls 222, while the wider regions 226a provide increased clearance. This bowtie geometry facilitates insertion of a mating feature (e.g., inserts 224) and further defines the predetermined amount of rotational play by allowing the mating feature to rotate within the wider regions 226a before contacting the sidewalls 222 at the narrower region 226b, at which point rotational input is transferred to the damper component 202 for damping.

Each damper component 202 includes an outer casing 210 and a rotor 212 disposed within the outer casing 210. The rotor 212 is configured to rotate relative to the outer casing 210. The rotor 212 and the outer casing 210 can be made of plastic material so that the components can be snapped (e.g., via a snap-in connection) or welded together (e.g., via ultrasonic welding). The snap-in connection can comprise an annular recess and an annular rib for reception within the annular recess. The annular recess can be on the assembly housing 206 and the annular rib can be on the outer casing 210 (or vice versa). In the illustrated example, the outer casing 210 is fixedly mounted to the assembly housing 206 via ultrasonic welding, snap-in connections, adhesives, or otherwise. The outer casing 210 may define an internal chamber that contains a viscous damping medium, such as silicone oil, grease, or another fluid having suitable rheological properties. The chamber may be sealed to retain the damping medium.

The damping torque of each damper component 202 can be affected by a number of factors. First, the damping torque generated is a function of the size of the surface area of the rotor and housing disposed in contact with the viscous fluid. That is, the damping torque increases when the dimensions of the body portion 104b is increased. Second, the viscosity of the type of viscous material is a variable for determining the amount of damper torque; however, the damper torque can also change as a function of the temperature and the rotation speed of the rotor 212. For example, at higher temperatures, the torque decreases as the viscosity of the viscous material decreases at higher temperatures. Therefore, the viscous material can be any suitable viscous flowable fluid that may be desired for a particular application (e.g., based on operating temperature, and speed). In some examples, the viscous material is a silicone oil or a silicone gel.

The rotor 212 may include, within the outer casing 210, internal vanes, fins, or other features that interact with the viscous medium during rotation. As the rotor 212 rotates relative to the outer casing 210, the viscous medium is displaced and sheared within narrow gaps or channels, generating resistance to motion. This resistance converts kinetic energy into thermal energy, thereby providing a damping effect.

Each rotor 212 includes a damper-coupling feature 218 configured to engage the axle-coupling feature 216 of the axle 204. In the illustrated example, the damper-coupling feature 218 includes one or more inserts 224 extending from the rotor 212. The inserts 224 may have a generally rectangular, blade-like, or tab-like configuration. In some embodiments, a pair of inserts 224 are provided, spaced apart to define a slot 232 therebetween.

The inserts 224 are configured to be received within the receiver recess 226 defined by the sidewalls 222 of the axle 204. The interaction between the inserts 224 and the sidewalls 222 enables transfer of rotational motion between the axle 204 and the rotor 212 while permitting a controlled degree of relative movement. For example, the geometry of the receiver recess 226 and inserts 224 may allow rotational play over a predefined angular range, such as approximately 30 degrees, although other ranges may be used. This controlled backlash may facilitate tolerance compensation, reduce stress concentrations, and enable staged engagement of the damping components.

Each damper component 202 may further include a pin recess 220 configured to receive a hinge pin or similar structural element. The pin recess 220 may extend partially or fully through the damper component 202, including through the outer casing 210 and the rotor 212. The pin recess 220 may be aligned with corresponding features in the assembly housing 206 or external components to facilitate mounting.

The outer casing 210 of each damper component 202 is secured within the assembly housing 206 such that the outer casing 210 is rotationally fixed relative to the housing 206. This may be achieved through one or more anti-rotation features. For example, the assembly housing 206 may include a slot 228 extending along a portion of its length, and the outer casing 210 may include a corresponding key feature 230, such as a rib or protrusion, configured to be received within the slot 228. Engagement between the key feature 230 and the slot 228 inhibits relative rotation.

Additional retention mechanisms may include press-fit engagement, friction fit, detent features, or other interference-based connections. Surface texturing, knurling, or other friction-enhancing features may also be used to increase resistance to rotation or axial displacement.

In some aspects, the assembly housing 206 and/or the damper components 202 include fixturing regions 120, 122. These fixturing regions may be recessed or flattened portions of the exterior surface configured to facilitate engagement with external brackets, tools, or fixtures. The fixturing regions 120, 122 may include planar surfaces, curved surfaces complementary to mating components, or other geometries that improve stability and alignment.

During operation, relative rotation between the first component 102 and the second component 104 results in rotation of the axle 204 relative to the assembly housing 206. This rotation is transmitted to the rotors 212 of the damper components 202 via the coupling features described above. As the rotors 212 rotate within the outer casings 210, viscous damping forces are generated within the damper components 202. These forces resist rotation, thereby producing a damping torque that opposes motion.

The damping torque moderates the movement of the first component 102 relative to the second component 104. For example, when the first component 102 is released from a closed position, the damper assembly 106 slows its movement toward the open position, preventing abrupt motion and providing a controlled, smooth user experience.

One or more components of the hinge damper assembly 106 (e.g., the axle 204, the outer casing 210, the rotor 212, and/or the assembly housing 206) can be fabricated from a plastic material using a plastic injection technique, additive manufacturing, or otherwise. For example, the hinge damper assembly 106, or one or more components thereof, can be fabricated from glass-reinforced polybutylene terephthalate (PBT). In some examples, the glass-reinforced PBT is a 30% glass-reinforced PBT material, such as Celanex 3300-2. In some examples, one or more components of the hinge damper assembly 106 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process).

While specific embodiments have been described, it will be understood that various modifications may be made. For example, the number, arrangement, and configuration of the spars 234, ribs 236, coupling features, and damping components may be varied. The damping medium, rotor geometry, and housing configuration may also be modified to achieve desired performance characteristics. Accordingly, the foregoing description is intended to be illustrative and not limiting.

While the present method and/or system have been described with reference to certain aspects, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the aspects disclosed. Instead, the present method and/or system will include all aspects falling within the scope of the appended claims, both literally and under the doctrine of equivalents.

1. A damper assembly for controlling motion between a first component and a second component, the damper assembly comprising:
an assembly housing configured to be coupled to at least one of the first component or the second component;
an axle disposed at least partially within the assembly housing and configured to rotate relative to the assembly housing, the axle being configured to at least one of the first component or the second component; and
at least one damper component coupled to the axle and positioned within the assembly housing,
wherein the at least one damper component is configured to provide resistance to rotation of the axle relative to the assembly housing.

2. The damper assembly of claim 1, wherein the damper assembly comprises a pair of damper components positioned at opposite ends of the axle.

3. The damper assembly of claim 1, wherein the assembly housing comprises a central region and a pair of end regions, the central region receiving the axle and the end regions receiving the at least one damper component.

4. The damper assembly of claim 1, wherein the assembly housing includes an opening through a sidewall providing access to the axle.

5. The damper assembly of claim 4, wherein the axle includes an engagement interface accessible through the opening and configured to couple the axle to the other of the first component or the second component.

6. The damper assembly of claim 5, wherein the engagement interface comprises at least one groove or slot.

7. The damper assembly of claim 1, wherein the axle comprises a plurality of longitudinally extending spars.

8. The damper assembly of claim 7, wherein the plurality of spars define an X-shaped cross-section.

9. The damper assembly of claim 7, further comprising a plurality of ribs extending between adjacent spars.

10. The damper assembly of claim 9, wherein at least a portion of the ribs define an engagement interface of the axle.

11. The damper assembly of claim 1, wherein the at least one damper component comprises:
an outer casing fixed relative to the assembly housing; and
a rotor disposed within the outer casing and coupled to the axle.

12. The damper assembly of claim 11, wherein the outer casing defines a chamber containing a viscous damping medium.

13. The damper assembly of claim 11, wherein the rotor is configured to rotate relative to the outer casing to generate a damping torque.

14. The damper assembly of claim 11, wherein the axle includes an axle-coupling feature and the rotor includes a corresponding damper-coupling feature configured to engage the axle-coupling feature.

15. The damper assembly of claim 14, wherein the axle-coupling feature comprises a pair of sidewalls defining a receiver recess.

16. The damper assembly of claim 15, wherein the receiver recess is configured to provide a predetermined amount of rotational play between the axle and the rotor prior to transmission of torque.

17. The damper assembly of claim 16, wherein the receiver recess includes a narrower region and one or more wider regions, the one or more wider regions providing clearance to permit relative rotation between the axle and the rotor, and the narrower region defining an engagement condition at which rotation of the axle is transferred to the rotor.

18. The damper assembly of claim 17, wherein the receiver recess has a bowtie-shaped geometry defining the narrower region between opposing wider regions.

19. The damper assembly of claim 14, wherein the damper-coupling feature comprises at least one insert configured to be received within the receiver recess, the at least one insert being movable within the receiver recess through the predetermined amount of rotational play prior to engagement with the axle-coupling feature.

20. The damper assembly of claim 1, wherein the damper assembly comprises a pin recess and a pin, wherein the pin is configured to extend and retract relative to the damper assembly via the pin recess.
